(19) United States
(12) Patent Application Publication
(10) Pub. No.: US 2026/0323291 A1
(43) Pub. Date: Oct. 15, 2026

(54) DEVICE REGISTRATION SYSTEM, TERMINAL DEVICE, AND METHOD

(71) Applicant: KABUSHIKI KAISHA TOSHIBA, Kawasaki-shi (JP)

(72) Inventor: Toshio ITO, Yokohama (JP)

(73) Assignee: KABUSHIKI KAISHA TOSHIBA, Kawasaki-shi (JP)

(21) Appl. No.: 19/462,514

(22) Filed: Jan. 28, 2026

(30) Foreign Application Priority Data
Mar. 12, 2025 (JP) 2025-039531

(51) Int. Cl. H04W 12/08; H04W 12/06; H04W 12/63

(52) U.S. Cl. CPC H04W 12/08; H04W 12/06; H04W 12/63

(57) ABSTRACT

According to one embodiment, a communication device transmits an authorization request to a first server device. The first server device transmits a device code and a proximity code to the communication device. The communication device transmits the proximity code to the terminal device. The terminal device transmits the proximity code to the first server device when the authorization request is permitted. The first server device verifies the proximity code and issues an access token. The communication device transmits an access token request to the first server device. The first server device transmits an access token to the communication device. The communication device transmits a device registration request to a second server device.

### CROSS-REFERENCE TO RELATED APPLICATIONS

This application is based upon and claims the benefit of priority from Japanese Patent Application No. 2025-039531, filed Mar. 12, 2025, the entire contents of which are incorporated herein by reference.

### FIELD

Embodiments described herein relate generally to a device registration system, a terminal device, and a method thereof.

### BACKGROUND

In recent years, various services are considered to be provided to using systems cyber-physical system (CPS) that can capture diverse data collected in the physical space (real space) into the cyber space (virtual space), analyze or process that data, and then feed the results back into the physical space to achieve optimization.

The above-described CPS is realized, for example, by a communication device that collects data (hereinafter referred to as a CPS device) and a server device (hereinafter referred to as a CPS server) connected to the CPS such as to be able to communicate with the device. That is, to make a CPS device usable within a CPS, it is necessary to register the CPS device with the CPS server and securely connect the CPS device to the CPS server.

Incidentally, the pre-setting operation performed to make CPS devices usable within the CPS is referred to as onboarding. Here, in order to properly operate the CPS, it is necessary to reduce the security threats (risks) associated with performing this onboarding and to prevent CPS devices from being registered fraudulently.

### BRIEF DESCRIPTION OF THE DRAWINGS

FIG. 1 is a diagram showing an example of a system configuration of a device registration system according to the first embodiment.

FIG. 2 is a diagram showing an example of a functional configuration of a CPS device.

FIG. 3 is a diagram showing an example of a functional configuration of an intermediary device.

FIG. 4 is a diagram showing an example of a functional the functional configuration of an authorization server.

FIG. 5 is a diagram showing an example of a functional configuration of a CPS server.

FIG. 6 is a diagram showing an example of a hardware configuration of the CPS device.

FIG. 7 is a sequence chart showing an example of the processing steps of the device registration system.

FIG. 8 is a diagram showing an example of an onboarding authorization request.

FIG. 9 is a diagram showing an example of an onboarding authorization response.

FIG. 10 is a diagram showing an example of session information.

FIG. 11 is a diagram showing an example of user information.

FIG. 12 is a diagram showing an example of an authorization request confirmation app screen.

FIG. 13 is a diagram illustrating application processing.

FIG. 14 is a diagram showing an example of an updated authorization request confirmation app screen.

FIG. 15 is a diagram showing an example of a device registration request.

FIG. 16 is a diagram showing an example of device information.

FIG. 17 is a diagram showing an example of a device registration response.

FIG. 18 is a diagram illustrating an example of a phishing attack.

FIG. 19 is a diagram showing an example of phishing mail.

FIG. 20 is a diagram showing an example of an authorization request confirmation app screen in a comparative example of this embodiment.

FIG. 21 is a sequence chart showing an example of the processing steps of a device registration system according to the second embodiment.

FIG. 22 is a diagram showing an example of an authorization request confirmation app screen.

FIG. 23 is a diagram showing an example of an updated authorization request confirmation app screen.

FIG. 24 is a diagram showing an example of a further updated authorization request confirmation app screen.

FIG. 25 is a diagram showing an example of a functional configuration of a CPS device in the third embodiment.

FIG. 26 is a diagram showing an example of a functional configuration of an intermediary device.

FIG. 27 is a sequence chart showing an example of the processing steps of the device registration system.

### DETAILED DESCRIPTION

In general, according to one embodiment, a device registration system is provided that includes a communication device, a terminal device, and a first server device. The communication device is configured to transmit an authorization request which requests authorization of the communication device, to the first server device. The first server device is configured to transmit a device code and a proximity code generated at the first server device in response to the authorization request, to the communication device. The communication device is in vicinity of the terminal device and is configured to transmit the proximity code transmitted from the first server device, to the terminal device. The terminal device is configured to transmit when the authorization request is permitted by a user using the terminal device, the proximity code transmitted from the communication device, to the first server device. The first server device is configured to verify the proximity code transmitted from the terminal device. The first server device is configured to issue an access token managed to be associated with the device code when the verification is successful. The communication device is configured to transmit an access token request including the device code transmitted from the first server device, to the first server device. The first server device is configured to transmit an access token managed to be associated with the device code included in the access token request transmitted from the communication device, to the communication device. The communication device is configured to transmit a device registration request including an access token transmitted from the first server device, to a second server device.

### BRIEF DESCRIPTION OF THE DRAWINGS

Various embodiments will be described with reference to the accompanying drawings.

### First Embodiment

First, the first embodiment will be described. The CPS can provide various services (functions) through communication between CPS devices and CPS servers. Here, in order to implement such CPS, it is necessary to register CPS devices with the CPS server. The device registration system according to this embodiment corresponds to the communication system used when registering CPS devices with the CPS server.

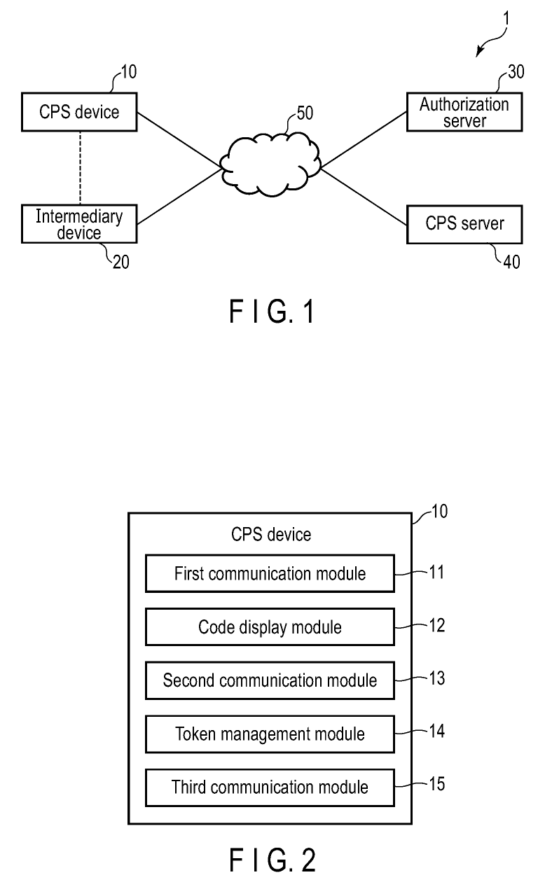

FIG. 1 shows an example of the system configuration of the device registration system according to this embodiment. As shown in FIG. 1, the device registration system 1 includes a CPS device 10, an intermediary device 20, an authorization server 30, and a CPS server 40.

The CPS device 10 is a communication device used to realize CPS and may, for example, be equipped with sensors, actuators, and the like.

The intermediary device 20 is a terminal device operated by the user. The intermediary device 20 is, for example, a smartphone, but may as well be some other electronic device. Note that the user in this embodiment is assumed to be, for example, the owner of the CPS device 10 or the administrator of the CPS server 40, but this user may as well be, for example, an installer entrusted with the installation work of the CPS device 10.

The authorization server 30 is a server device that operates to authorize the CPS device 10 and issue an access token in response to instructions from the user. When the access token issued by the authorization server 30 is submitted from the CPS device 10 to the CPS server 40, registration of the CPS device 10 with the CPS server 40 is completed.

As described above, when the CPS device 10 is registered with the CPS server 40, the CPS device 10 becomes available for realizing the CPS. It can then operate to upload data measured by sensors mounted on the CPS device 10 to the CPS server 40 or to control actuators mounted on the CPS device 10 in response to instructions received from the CPS server 40.

The CPS server 40 is a server device constituting the CPS, and it operates to provide various services (functions) by communicating with the CPS device 10. The CPS server 40 may be built on a cloud service or on-premises. Further, the CPS server 40 may be built within an access point or base station located within a communication infrastructure.

In this embodiment, it is assumed that the CPS device 10 is already connected to the network 50. With this configuration, the CPS device 10 can communicate with the authorization server 30 and the CPS server 40 via the network 50. Similarly, it is assumed that the intermediary device 20 can communicate with the authorization server 30 via the network 50. The network 50 to which the CPS device 10 is connected and the network 50 to which the intermediary device 20 is connected may be the same or different. The CPS device 10 may be connected to the network 50 via a wireless local area network (LAN), while the intermediary device 20 may be connected to the network 50 via a mobile communication line (mobile network).

Furthermore, in this embodiment, the CPS device 10 and the intermediary device 20 are configured, for example, to be capable of performing short-range wireless communications. Note that the short-range wireless communications performed between the CPS device 10 and the intermediary device 20 in this embodiment is, for example, communications based on Bluetooth® Low Energy (BLE).

Incidentally, the preliminary setup work performed to enable the CPS device 10 usable in the above-described CPS (registration of the CPS device 10 with the CPS server 40) is referred to as onboarding. The following is a description on the outline of the onboarding corresponding to a comparative example of this embodiment. In the comparative example of this embodiment, onboarding is performed using a method employing RFC 8628 (OAuth 2.0 Device Authorization Grant).

In the comparative example of this embodiment, first, the CPS device 10 subject to onboarding transmits an authorization request (hereinafter referred to as an onboarding authorization request) requesting authorization for the onboarding of that CPS device 10 to the authorization server 30, and the CPS device 10 receives a URI string referred to as a verification URI (Uniform Resource Identifier) from the authorization server 30. Then, the CPS device 10 converts the verification URI into a QR code (registered trademark) and displays it on the display of the CPS device 10. The user logs into the authorization server 30 by reading (scanning) the QR code displayed on the display of the CPS device 10 using the camera of the intermediary device 20 (for example, a smartphone), and thus permits the onboarding authorization request from the CPS device 10. When the

onboarding authorization request from the CPS device 10 is thus permitted by the user, an access token associated with the user is issued by the authorization server 30, and then this issued access token is submitted to the CPS server 40, thus registering the CPS device 10 with the CPS server 40.

Here, nota that in the onboarding described in the comparative example of this embodiment, it has been pointed out to be possible that a CPS device could be fraudulently registered, for example, through phishing attacks. If an attacker's CPS device is registered with the victim's (user's) CPS server via a phishing attack, it becomes possible to fraudulently access that CPS server from that CPS device, making it highly probable that the secure operation of the CPS will be compromised.

Therefore, this embodiment proposes a device registration system 1 that can automatically perform onboarding while reducing security threats (risks) such as the unauthorized registration of CPS devices.

Note that this embodiment is described on the assumption that the device registration system 1 includes a CPS device 10, an intermediary device 20, an authorization server 30, and a CPS server 40. But, the device registration system 1 according to this embodiment may as well have a configuration where some of the CPS device 10, intermediary device 20, authorization server 30, and CPS server 40 (or their functions) are omitted.

FIG. 2 shows an example of the functional configuration of the CPS device 10 in this embodiment. As shown in FIG. 2, the CPS device 10 includes a first communication module 11, a code display module 12, a second communication module 13, a token management module 14, and a third communication module 15.

The first communication module 11 performs communication with the authorization server 30 via the network 50. The first communication module 11 transmits an onboarding authorization request to the authorization server 30 and receives, for example, a device code, a user code, and a proximity code from the authorization server 30 in response to the onboarding authorization request. Further, the first communication module 11 receives a verification URI, which corresponds to access information for accessing the authorization server 30, from the authorization server 30.

The code display module 12 converts the verification URI received by the first communication module 11 into a QR code format and displays the QR code. Note that the QR code corresponds to a two-dimensional code representing access information for accessing the authorization server 30.

The second communication module 13 performs communication based on the above-described BLE (hereinafter referred to as BLE communication) with the intermediary device 20. By performing BLE communication, the second communication module 13 transmits the hash value of the user code and the proximity code received by the first communication module 11 to the intermediary device 20. Note here that the hash value of the user code is derived from the user code using a hash function such as SHA-256.

The token management module 14 manages the access token issued by the authorization server 30 when an onboarding authorization request is approved by a user using the intermediary device 20, as will be described later.

The third communication module 15 performs communication with the CPS server 40 via the network 50. The third communication module 15 requests registration of the CPS device 10 to the CPS server 40 by transmitting a device registration request, including the access token managed by the token management module 14, to the CPS server 40.

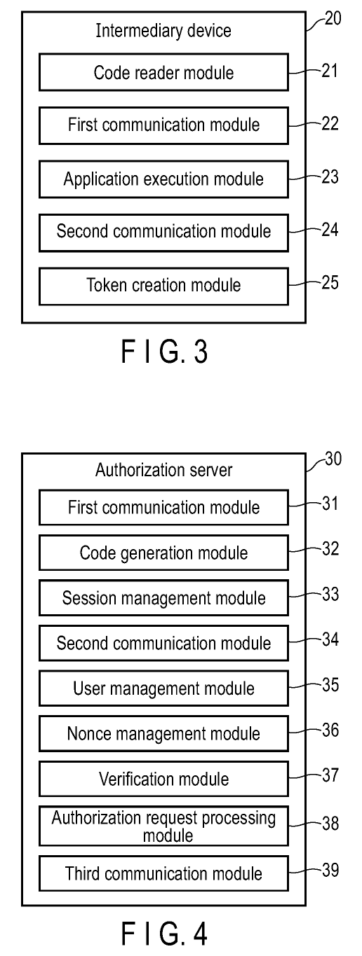

FIG. 3 shows an example of the functional configuration of the intermediary device 20 in this embodiment. As shown in FIG. 3, the intermediary device 20 includes a code reader module 21, a first communication module 22, an application execution module 23, a second communication module 24, and a token creation module 25.

The code reader module 21 reads the QR code displayed by the code display module 12 included in the above-described CPS device 10.

When the QR code is read by the code reader module 21, the intermediary device 20 becomes capable of accessing the authorization server 30. The first communication module 22 performs communication with the authorization server 30 via the network 50. Note that the first communication module 22 is, for example, implemented by a web browser operating on the intermediary device 20 and performs communication according to HyperText Transfer Protocol Secure (HTTPS).

The application execution module 23 executes an authorization request confirmation application program (hereinafter referred to as the authorization request confirmation app). The authorization request confirmation app is an application program that allows the user to confirm the contents of the onboarding authorization request transmitted from the CPS device 10 (first communication module 11). It is distributed from the authorization server 30 and executed on the intermediary device 20. The authorization request confirmation app is composed of, for example, HyperText Markup Language (HTML) and JavaScript (registered trademark) code.

The second communication module 24 performs BLE communication with the CPS device 10. By performing BLE communication, the second communication module 24 receives the hash value of the user code and the proximity code transmitted from the CPS device 10 (second communication module 13).

The token creation module 25 creates a proximity attestation token based on the hash value of the user code and the proximity code received by the second communication module 24. The proximity attestation token created by the token creation module 25 is transmitted to the authorization server 30 by the first communication module 22 and is verified at the authorization server 30 when issuing an access token.

FIG. 4 shows an example of the functional configuration of the authorization server 30 in this embodiment. As shown in FIG. 4, the authorization server 30 includes a first communication module 31, a code generation module 32, a session management module 33, a second communication module 34, a user management module 35, a nonce management module 36, a verification module 37, an authorization request processing module 38, and a third communication module 39.

The first communication module 31 performs communication with the CPS device 10 via the network 50. The first communication module 31 receives the onboarding authorization request transmitted from the CPS device 10 (first communication module 11).

When the onboarding authorization request is received by the first communication module 31, the code generation module 32 generates a device code, a user code, and a proximity code. The device code, user code, and proximity code are generated as random strings, respectively. Further, the code generation module 32 generates the verification URI described above. The device code, user code, proximity code, and verification URI generated by the code generation module 32 are transmitted to the CPS device 10 by the first communication module 31 as a response to the onboarding authorization request described above.

The session management module 33 manages (stores) information (hereinafter referred to as session information) concerning the onboarding authorization request (session) received by the first communication module 31. As will be described in detail later, the session information includes the device code, user code, and proximity code generated by the code generation module 32 in association with the session ID assigned to the session information.

The second communication module 34 performs communication with the intermediary device 20 via the network 50. As described above, when the authorization server 30 is accessed from the intermediary device 20, the second communication module 34 transmits (distributes) the authorization request confirmation app to the intermediary device 20. Further, the second communication module 34 receives the proximity attestation token transmitted from the intermediary device 20 (first communication module 22).

The user management module 35 manages authentication information, such as a user ID (for example, email address) for identifying the user and a password set for that user, as account information (hereinafter referred to as user information) for users accessing the authorization server 30 using the intermediary device 20. The user information managed by the user management module 35 is used, for example, when the user logs into the authorization server 30.

The nonce management module 36 generates (issues) a nonce, which is a random string, and manages it by associating it with an expiration time. The nonce managed by the nonce management module 36 is transmitted to the intermediary device 20 by the second communication module 34 and is used when creating the proximity attestation token described above.

The verification module 37 verifies the (validity of the) proximity attestation token received by the second communication module 34.

The authorization request processing module 38 executes processing to approve or deny the onboarding authorization request based on the verification result from the verification module 37. When the onboarding authorization request is approved, the authorization request processing module 38 issues an access token for that request. The access token issued by the authorization request processing module 38 is set in the session information managed by the session management module 33 and is transmitted to the CPS device 10 in response to a request from the CPS device 10.

The third communication module 39 performs communication with the CPS server 40 via the network 50. The third communication module 39 receives the access token transmitted from the CPS server 40 when a device registration request (access token) is transmitted from the CPS device 10 (third communication module 15) to the CPS server 40, and transmits the information necessary to register the CPS device 10 with the CPS server 40 (information related to the access token) to the CPS server 40.

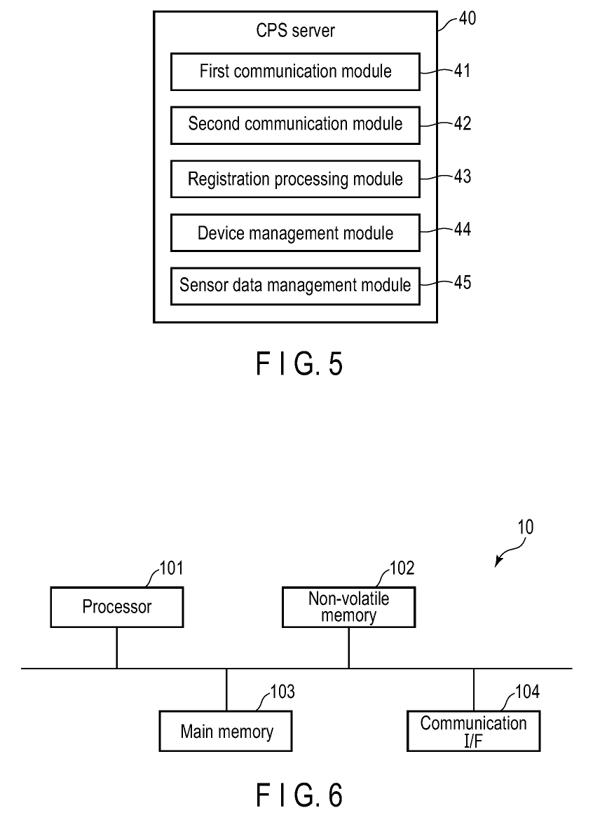

FIG. 5 shows an example of the functional configuration of the CPS server 40 in this embodiment. As shown in FIG. 5, the CPS server 40 includes a first communication module 41, a second communication module 42, a registration processing module 43, a device management module 44, and a sensor data management module 45.

The first communication module 41 performs communication with the CPS device 10 via the network 50. The first communication module 41 receives a device registration request transmitted from the CPS device 10 (third communication module 15) to request registration of the CPS device 10.

The second communication module 42 performs communication with the authorization server 30 via the network 50. The second communication module 42 transmit the access token included in the device registration request received by the first communication module 41 to the authorization server 30 and receives information regarding that access token from the authorization server 30 (third communication module 39).

The registration processing module 43 executes processing to register the CPS device 10 with the CPS server 40 based on the information regarding the access token received by the second communication module 42.

The device management module 44 manages information regarding CPS devices 10 already registered with the CPS server 40.

The sensor data management module 45 manages sensor data (data measured by sensors mounted on the CPS device 10) uploaded from the CPS device 10 registered with the CPS server 40.

FIG. 6 shows an example of the hardware configuration of the CPS device 10 described above. As shown in FIG. 6, the CPS device 10 includes a processor 101, non-volatile memory 102, main memory 103, and a communication interface (I/F) 104, and the like.

The processor 101 is configured to control the operation of each component within the CPS device 10 and may be, for example, a CPU. The processor 101 may be a single processor or may be composed of multiple processors. The processor 101 executes various programs loaded from the non-volatile memory 102 into the main memory 103. The communication interface 104 is an interface for implementing communication with, for example, the intermediary device 20, the authorization server 30, and the CPS server 40.

In this embodiment, some or all of the components 11 to 15 shown in FIG. 2 may be implemented by causing the processor 101 shown in FIG. 6 to execute a predetermined program (that is, software), by hardware such as an integrated circuit (IC), or by a combination of software and hardware.

Note that although omitted in FIG. 6, the CPS device 10 is assumed to be further provided with sensors, actuators, and the like. Further, the CPS device 10 is assumed to be further provided with a display for displaying the QR code described above.

Here, the hardware configuration of the CPS device 10 is described, but it is assumed that the intermediary device 20, authorization server 30, and CPS server 40 as well have substantially similar hardware configurations.

In this case, some or all of the components 21 to 25 shown in FIG. 3 may be implemented by executing a predetermined program (that is, software) on a processor (CPU) contained in the intermediary device 20, may be implemented by hardware, or may be implemented by a combination of software and hardware.

Further, when the intermediary device 20 is, for example, a smartphone, the intermediary device 20 is assumed to be further provided with a touchscreen display composed of a touch panel and a display. Furthermore, the intermediary device 20 is assumed to be further provided with a camera for reading the QR code displayed on the display of the CPS device 10 as described above.

Moreover, the token creation module 25 included in the intermediary device 20 may be implemented within the hardware (wireless chip performing BLE communication) for the BLE communication, since it creates a proximity attestation token based on a proximity code transmitted via BLE communication, for example.

Further, some or all of the components 31 to 39 shown in FIG. 4 may be implemented by executing a predetermined program (that is, software) on a processor (CPU) contained in the authorization server 30, may be implemented by hardware, or may be implemented by a combination of software and hardware.

Furthermore, some or all of the components 41 to 45 shown in FIG. 5 may be implemented by executing a predetermined program on the processor (CPU) contained in the CPS server 40 (that is, software), may be implemented by hardware, or by a combination of software and hardware.

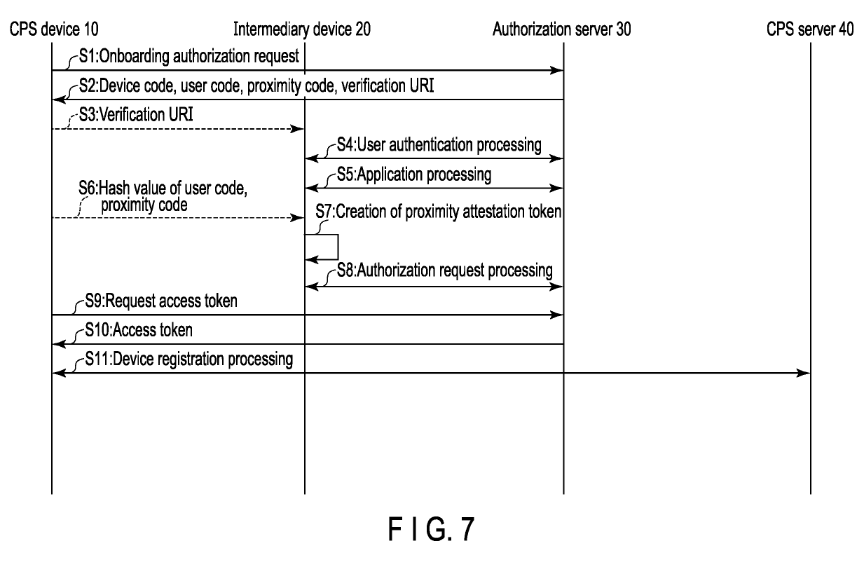

With reference to the sequence chart in FIG. 7, an example of the processing procedure (operation sequence) of the device registration system 1 according to this embodiment will now be described.

Note that at the time of start of the processing shown in FIG. 7, the CPS device 10 is assumed to be in a state where it is communicatively connected to the authorization server 30 and the CPS server 40. Here, the state where the CPS device 10 is communicatively connected to the authorization server 30 and CPS server 40 means that the CPS device 10 is connected to the network 50 and holds the addresses of the authorization server 30 and CPS server 40. Further, in this embodiment, the authorization server 30 and CPS server 40 operate, for example, as HTTPS servers. The CPS device 10 can authenticate these servers using the server certificates provided by the servers, and thus it can achieve secure communication with the authorization server 30 and CPS server 40.

Furthermore, the intermediary device 20 is in a state where it is communicatively connected to the authorization server 30 and the CPS server 40. Therefore, a user using the intermediary device 20 is assumed to have a user account pre-registered with the authorization server 30 and the CPS server 40.

Here, in this embodiment, the CPS device 10 is in a pre-onboarding state. It is assumed that the CPS server 40 cannot authenticate the CPS device 10 and cannot accept sensor data and the like, from the CPS device 10 (that is, it cannot utilize the CPS device 10 to implement CPS). The device registration system 1 according to this embodiment executes processing to register the CPS device 10 with the CPS server 40, in order to create such a state where the CPS device 10 in this pre-onboarding state is rendered usable.

First, it is assumed that the user powers on the CPS device 10 in its pre-onboarding state and performs a predetermined operation, such as pressing a button provided on the CPS device 10. Thus, the first communication module 11 included in the CPS device 10 transmits an onboarding authorization request to the authorization server 30 (step S1).

When the processing of step S1 is executed, the first communication module 31 included in the authorization server 30 receives the onboarding authorization request transmitted in step S1.

Next, the code generation module 32 included in the authorization server 30 generates a device code, a user code, and a proximity code. The device code, user code, and proximity code are random strings respectively different from each other.

Further, the code generation module 32 generates a verification URI containing the generated user code. In this case, for example, a verification URI with the user code appended as a query parameter may be generated. The verification URI is the URI used by the authorization server 30 to distribute the authorization request confirmation app and is used when the intermediary device 20 accesses the authorization server 30.

The first communication module 31 transmits the above-described device code, user code, proximity code, and verification URI to the CPS device 10 as a response to the onboarding authorization request (hereinafter referred to as the onboarding authorization response) (step S2).

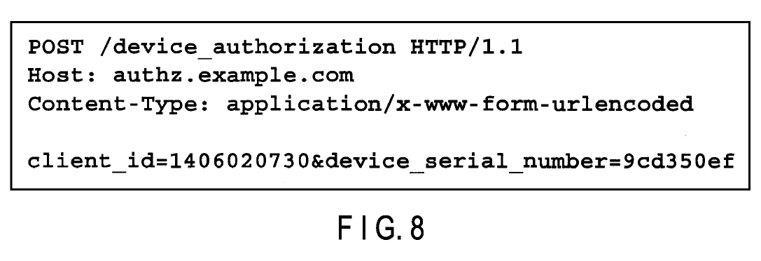

FIG. 8 shows an example of the onboarding authorization request transmitted in step S1. Note that the onboarding authorization request takes the form of a device authorization request described, for example, in RFC 8628.

According to the example shown in FIG. 8, the authorization server 30 operates under the hostname “authz.example.com”. The parameter written as “client_id”, included in the onboarding authorization request shown in FIG. 8 is a client identifier pre-registered with the authorization server 30. It is assumed that the “client_id” is registered with the authorization server 30, for example, by the manufacturer of the CPS device 10 and is recorded in the CPS device 10 during the manufacture thereof. Further, the parameter written as “device_serial_number”, included in the onboarding authorization request shown in FIG. 8 is the serial number of the CPS device 10, and is recorded within the CPS device 10 during the manufacture thereof.

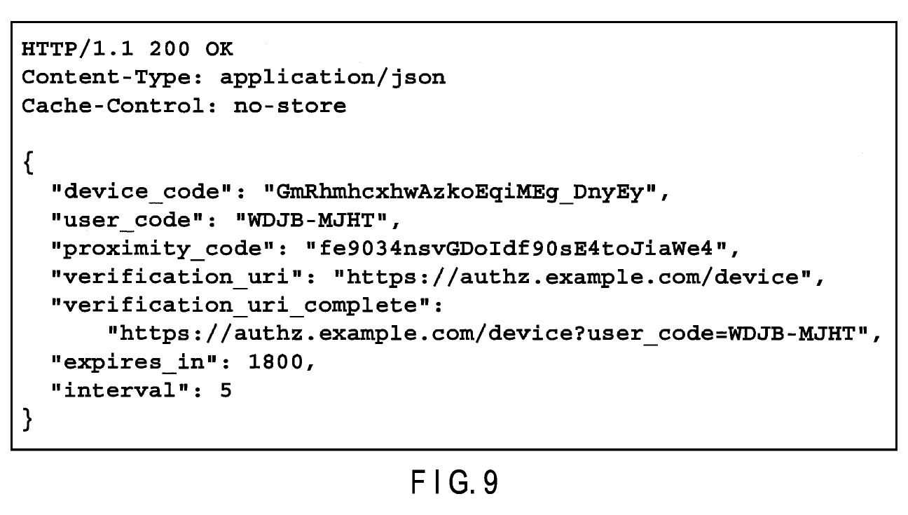

FIG. 9 also shows an example of the onboarding authorization response transmitted in step S2. The onboarding authorization response is a message in JavaScript Object Notation (JSON) format.

The parameters described as “device_code”, “user_code”, “proximity_code”, and “verification_uri_complete” included in the onboarding authorization response (JSON object), shown in FIG. 9 correspond to the above-described device code, user code, proximity code, and verification URI.

Incidentally, when the device code, user code, and proximity code are generated as described above, the session management module 33 included in the authorization server 30 generates session information containing the device code, user code, proximity code, and the like, and manages the session information.

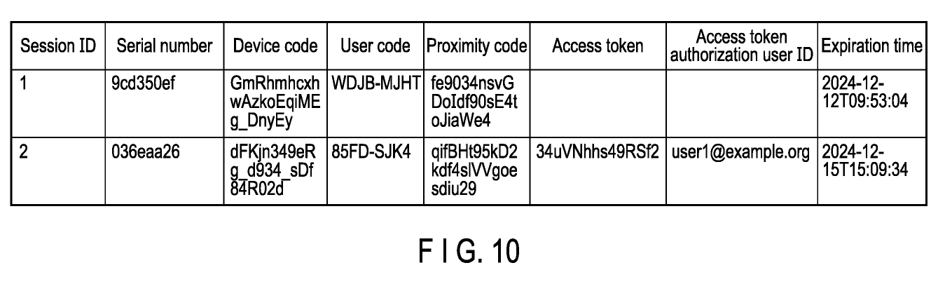

FIG. 10 shows an example of the session information. As shown in FIG. 10, the session information includes a serial number, device code, user code, proximity code, access token, access token authorization user ID, and expiration time, associated with the session ID assigned to that session information.

The serial number is the value of “device_serial_number” included in the onboarding authorization request described above.

The device code, user code, and proximity code are the values of “device_code”, “user_code”, and “proximity_code” included in the onboarding authorization response described above.

FIG. 10 shows session information whose session ID is “1” and session information whose session ID is “2”. Note here that session information generated as a new entry by the session management module 33 has an access token and an access token authorization user ID that are blank, as in the case of the session information whose session ID is “1”. In other words, the session information whose session ID is “1” indicates that an access token has not yet been issued for the session (onboarding authorization request) with that session ID. On the other hand, the session information whose session ID is “2” indicates that an access token has already been issued for the session (onboarding authorization request) with that session ID.

The expiration time is set when the session information is generated, and session information whose expiration time has passed is discarded (deleted) at a predetermined time.

Referring back to FIG. 7, the first communication module 11 included in the CPS device 10 receives the onboarding authorization response transmitted in step S2. When the onboarding authorization response is received by the first communication module 11 in this manner, processing is executed to pass the verification URI included in the onboarding authorization response from the CPS device 10 to the intermediary device 20 (step S3).

Specifically, the code display module 12 included in the CPS device 10 encodes the verification URI contained in the onboarding authorization response received by the first communication module 11 into a QR code and displays this QR code on the display provided on the CPS device 10. The code reader module 21 included in the intermediary device 20 decodes the QR code by reading the QR code displayed on the CPS device 10 using the camera provided on the intermediary device 20, thereby obtaining the verification URI. Thus, the transfer of the verification URI from the CPS device 10 to the intermediary device 20 is completed.

As described above, when the QR code is read by the code reader module 21 (the verification URI is obtaind), a web browser is launched on the intermediary device 20, and the intermediary device 20 accesses the authorization server 30 based on the verification URI. According to the example of the onboarding authorization response shown in the above FIG. 9, the intermediary device 20 (web browser) accesses “authz.example.com/device?user_code=WDJB-MJHT".

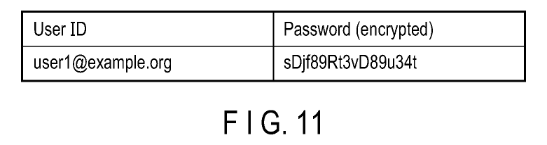

Upon receiving the access from the intermediary device 20, the authorization server 30 performs user authentication processing for the user using the intermediary device 20 (step S4). As described above, the user has a user account pre-registered with the authorization server 30, and the user information related to the user account is managed by the user management module 35 included in the authorization server 30. FIG. 11 shows an example of the user information, which includes a user ID and a password (encrypted) associated with each other.

In this case, in step S4, the authorization server 30 prompts the user to log in to the authorization server 30 and requests the entry of the user ID and the password. The user responds to this request from the authorization server 30 by entering the user ID for identifying the user and the password set for that user into the intermediary device 20. The authorization server 30 receives the user ID and password entered by the user (hereinafter referred to as the input information) from the intermediary device 20 and checks the received input information with the above-described user information (user ID and password). If the input information matches the user information, the authorization server 30 permits the user's login and issues a login cookie to the web browser operating on the intermediary device 20. This login cookie is used in subsequent communications between the intermediary device 20 and the authorization server 30.

Here, the second communication module 34 included in the authorization server 30 transmits an authorization request confirmation app to the intermediary device 20 as a response to the web browser operating on the intermediary device 20. That is, the user authentication process executed in step S4 corresponds to the process described above, which permits the user's login to the authorization server 30 and delivers the authorization request confirmation app to the intermediary device 20.

The authorization request confirmation app transmitted from the authorization server 30 (second communication module 34), as described above, is received by the first communication module 22 included in the intermediary device 20 and executed on the web browser by the application execution module 23.

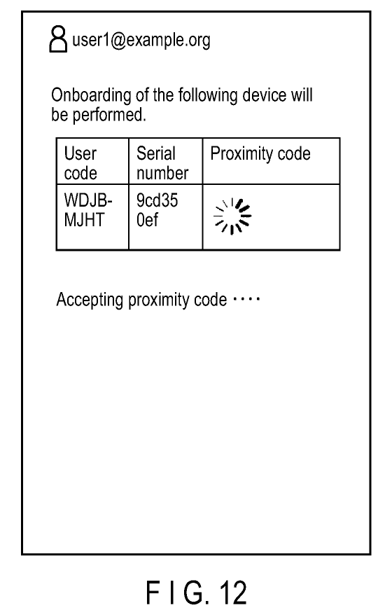

FIG. 12 shows an example of a screen (hereinafter referred to as the authorization request confirmation app screen) displayed on the intermediary device 20 (for example, a touchscreen display) via the web browser at the initial state when the authorization request confirmation app is executed by the application execution module 23.

The authorization request confirmation app screen shown in FIG. 12 indicates that the user has logged into the authorization server 30 using the email address “user1@example.org” as the user ID.

Further, the authorization request confirmation app screen shown in FIG. 12 displays the user code “WDJB-MJHT” provided as the query parameter (user_code=WDJB-MJHT) in the verification URI, along with the serial number “9cd350ef” contained in the session information associated with that user code.

That is, the user can confirm the user code “WDJB-MJHT” and the serial number “9cd350ef” as the contents of the onboarding authorization request.

As shown in FIG. 12, the authorization request confirmation app screen is provided with an area for displaying the proximity code. Note here that the example shown in FIG. 12 indicates that the authorization request confirmation app is in a state where it has accepted the proximity code from the CPS device 10.

Here, the proximity confirmation app executes a predetermined process (hereinafter referred to as the application process) in the background (step S5).

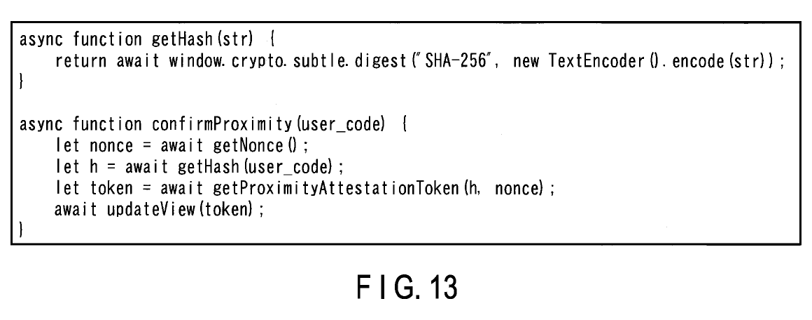

FIG. 13 shows an example of JavaScript code (the confirmProximity function) representing the application process.

According to the getNonce function defined within the confirmProximity function, the application execution module 23 (hereinafter referred to simply as the authorization request confirmation app) running the authorization request confirmation app on the web browser executes processing to obtain a nonce from the authorization server 30. Note that the nonce is generated by the nonce management module 36 included in the authorization server 30 and is managed by the nonce management module 36 in association with its expiration time.

Further, according to the getHash function defined within the confirmProximity function, the authorization request confirmation app executes processing to obtain the hash value of the user code displayed on the authorization request confirmation app screen.

Furthermore, according to the getProximityAttestationToken function defined within the confirmProximity function, the authorization request confirmation app executes processing to obtain the proximity attestation token corresponding to the variable h (hash value of the user code) and the nonce. Note here that the proximity attestation token will be described later.

Furthermore, according to the updateView function defined within the confirmProximity function, the authorization request confirmation app executes processing to update the authorization request confirmation app screen according to (the value of) the proximity attestation token when such a token is obtaind.

In the getProximityAttestationToken function described above, in order to obtain a proximity attestation token, a request is made to the token creation module 25 included in the intermediary device 20 to create the proximity attestation token. In response to such a request, the proximity attestation token creation module 25 instructs the second communication module 24 to wait for (stand by to receive) the proximity code.

Referring back to FIG. 7, after the processing of step S3 is executed (that is, the code display module 12 included in the CPS device 10 displays the QR code), the CPS device 10 derives (obtains) the hash value of the user code from the user code received by the first communication module 11 as the onboarding authorization response. The second communication module 13 included in the CPS device 10 transmits the hash value of the user code derived in this manner and the proximity code received by the first communication module 11 as the onboarding authorization response via BLE communication (step S6). Note that in step S6, the hash value of the user code and the proximity code are transmitted, for example, by means such as a broadcast frame in BLE communication. Specifically, for example, the advertising physical channel PDU of BLE communication can be used. Further, the processing of step S6 is repeatedly executed at regular intervals.

When a user is in the vicinity of the CPS device 10, the second communication module 24 included in the intermediary device 20 used by that user can receive the hash value of the user code and proximity code transmitted in step S6. When the second communication module 24 receives the hash value of the user code and proximity code, it passes these to the token creation module 25.

In this case, the token creation module 25 determines whether or not the hash value of the user code passed from the second communication module 24 (that is, the hash value of the user code received via BLE communication) and the hash value of the user code received from the getProximityAttestationToken function described in FIG. 13 described above match with each other.

If the hash values of the user code do not match, the hash value of the user code and proximity code (BLE message) passed from the second communication module 24 are discarded.

On the other hand, if the hash values of the user code match, the token creation module 25 creates a proximity attestation token using the hash value of the user code and the proximity code passed from the second communication module 24, and the nonce received from the getProximityAttestationToken function (step S7).

The processing of step S7 will now be described. First, the token creation module 25 creates a payload containing the hash value of the user code, the proximity code, and the nonce. Specifically, for example, a JSON object containing the hash value of the user code, the proximity code, and the nonce is generated.

Further, the token creation module 25 creates an electronic signature for the generated payload. The electronic signature is created using a private key managed by the token creation module 25.

The token creation module 25 creates a proximity attestation token (a message with an electronic signature applied to the payload) containing the above-described payload and electronic signature.

Note that the proximity attestation token created by the token creation module 25 is, for example, in the format of a JSON Web Token (JWT, RFC7519) or Entity Attestation Token (EAT, draft-ietf-rats-eat-31).

When the processing of step S7 is executed, the token creation module 25 provides the proximity attestation token created in step S7 to the authorization request confirmation app. Consequently, the authorization request confirmation app obtains the proximity attestation token as the return value of the above-described getProximityAttestationToken function and updates the authorization request confirmation app screen via the updateView function.

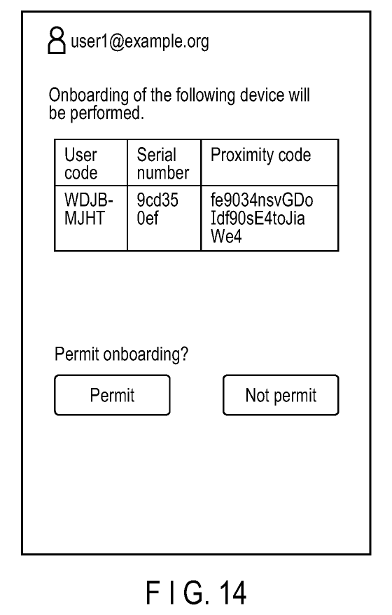

FIG. 14 shows an example of the updated authorization request confirmation app screen as described above. Unlike the authorization request confirmation app screen shown in FIG. 12, the screen shown in FIG. 14 displays the proximity code contained in (the payload of) the proximity attestation token.

Further, the authorization request confirmation app screen shown in FIG. 14 includes two buttons for instructing whether or not to permit the onboarding authorization request (that is, onboarding to the CPS device 10) confirmed by the user code, serial number, and proximity code displayed on that authorization request confirmation app screen.

On this authorization request confirmation app screen, the user can permit the onboarding authorization request by performing the operation of pressing the button labeled “Permit.” On the other hand, in the authorization request confirmation app screen, the user can deny (that is, reject) the onboarding authorization request from CPS device 10 by performing the operation of pressing the button labeled “Not Permit.”

If the user permits the onboarding authorization request from the CPS device 10, the first communication module 22 included in the intermediary device 20 transmits the user code and the proximity attestation token to the authorization server 30, to notify the authorization server 30 that the user has permitted the onboarding authorization request from the CPS device 10 (that is, the user's instruction to permit the onboarding authorization request).

The user code and proximity attestation token transmitted from the intermediary device 20 (first communication module 22) are received by the first communication module 31 included in the authorization server 30 and verified by the verification module 37 included in the authorization server 30. In this case, the verification module 37 performs, for example, the first to seventh verification processes.

The first verification process verifies that the electronic signature included in the proximity attestation token is valid. The first verification process (that is, verification of the electronic signature) uses the public key, which is in pair with the private key (the private key managed by the token creation module 25) used to create that electronic signature. Note that the public key used for verifying the electronic signature is assumed to be already registered with the authorization server 30 at the time the process shown in FIG. 7 is executed. The registration operation of this public key may be performed when the user creates an account with the authorization server 30, or it may be performed in advance by the manufacturer of the intermediary device 20 (component). Further, the public key may be stored on a key distribution server managed and published by a third party, rather than on the authorization server 30. In this case, during the above-described verification of the electronic signature, the authorization server 30 may obtain (receive) the public key used for that verification from the key distribution server.

The second verification process verifies that the nonce contained in (the payload of) the proximity attestation token was issued by the nonce management module 36 and is within its validity period. Note that the second verification process is executed based on the nonce and validity period managed by the nonce management module 36.

The third verification process verifies that the hash value of the user code derived from the user code transmitted from the intermediary device 20 matches the hash value of the user code contained in (the payload of) the proximity attestation token transmitted from the intermediary device 20.

The fourth verification process verifies that the session information (hereinafter referred to as the target session) containing the user code transmitted from the intermediary device 20 is managed by the session management module 33 (that is, that the user code exists in the session management module 33).

The fifth verification process verifies that the expiration period of the target session information has not passed. The fifth verification process is executed based on the expiration time contained within the target session information.

The sixth verification process verifies that the proximity code contained in the target session information matches the proximity code contained within the proximity attestation token transmitted from the intermediary device 20.

The seventh verification process verifies that the target session information does not contain an access token (that is, that no access token corresponding to the target session information has been issued).

The results of the first to seventh verification processes described above (verification results) are passed from the verification module 37 to the authorization request processing module 38. The authorization request processing module 38 executes processing to permit or deny the onboarding authorization request based on the results of the first to seventh verification processes (hereinafter referred to as the authorization request processing) (step S8). Note that the processing of the authorization request corresponds to the processing of determining whether or not to authorize the CPS device 10 targeted for onboarding.

In this case, if all of the above-described verification processes 1 to 7 are successful, the authorization request processing module 38 permits the onboarding authorization request according to the user's instruction described above and issues (generates) a new access token, which is a random string. The access token issued by the authorization request processing module 38 is set (stored) in the column of “Access Token” of the target session information managed by the session management module 33. Further, in the column of “Access Token Authorized User ID” of the target session information, the user ID obtained when the user logged into the authorization server 30 is set (stored) (that is, the user ID for identifying the user using the intermediary device 20 that transmitted the proximity attestation token).

Once the issuance of the access token is completed as described above, the second communication module 34 included in the authorization server 30 notifies the intermediary device 20 that the onboarding authorization request has been permitted (that is, the issuance of the access token was successful).

On the other hand, if verification fails in at least one of the first to seventh verification processes described above, the authorization request processing module 38 rejects the onboarding authorization request and does not issue an access token. In this case, the second communication module 34 notifies the intermediary device 20 that the onboarding authorization request was rejected (that is, the issuance of the access token failed).

Here, the description is made in assumption that the verification module 37 executes the verification processes 1 to 7. But, some of these verification processes 1 to 7 may be omitted, or additional verification processes different from the verification processes 1 to 7 may as well be executed.

Here, after the processing of step S3 is executed (that is, the code display module 12 included in the CPS device 10 displays the QR code), the first communication module 11 included in the CPS device 10 presents the device code received by the first communication module 11 as an onboarding authorization response to the authorization server 30 and requests an access token (step S9). In step S9, an access token request (message) containing the device code is transmitted from the CPS device 10 (first communication module 11) to the authorization server 30. This access token request is, for example, a Device Access Token Request described in RFC 8628.

When the processing of step S9 is executed, the first communication module 31 included in the authorization server 30 receives the access token request transmitted in the step S9.

In this case, the session management module 33 included in the authorization server 30 searches for session information containing the device code (hereinafter referred to as the target device code) included in the access token request received by the first communication module 31 from among the multiple session information managed by the session management module 33.

If session information containing the target device code is not found (does not exist), the first communication module 31 transmits (replies) a message that rejects the access token request from the CPS device 10 to the CPS device 10. When this message is received by the first communication module 11 included in the CPS device 10, the CPS device 10 terminates all processing related to the onboarding authorization request transmitted in step S1 (all processing for onboarding).

Further, if session information containing the target device code is found (exists), but the access token is not included in that session information (that is, the “access token” column is blank), the first communication module 31 transmits (replies) a message indicating that the access token request from the CPS device 10 is in a pending state to the CPS device 10. When this message is received by the first communication module 11 included in the CPS device 10, the CPS device 10 stands by for a predetermined time and then executes the processing of step S9 again.

On the other hand, if session information containing the target device code is found and the access token is included in that session information (that is, the “Access Token” column is not blank), the first communication module 31 transmits (replies with) the access token included in that session information to the CPS device 10 (step S10).

When the processing of step S10 is executed, the first communication module 11 included in the CPS device 10 receives the access token transmitted in step S10. When the access token is received in this manner, the processing of step S6 (that is, the periodic transmission processing of the hash value of the user code and the proximity code) executed at regular intervals in the CPS device 10 is stopped.

Next, the third communication module 15 included in the CPS device 10 presents the access token received by the first communication module 11 to the CPS server 40 and requests registration of the CPS device 10 with the CPS server 40. In this case, a device registration request (message) containing the access token is transmitted from the CPS device 10 (third communication module 15) to the CPS server 40.

The first communication module 41 included in the CPS server 40 receives the device registration request transmitted from the CPS device 10 (third communication module 15).

Accordingly, the registration processing module 43 included in the CPS server 40 executes processing to register the CPS device 10 using the access token included in the device registration request received by the first communication module 41 (hereinafter referred to as the device registration process) (step S11).

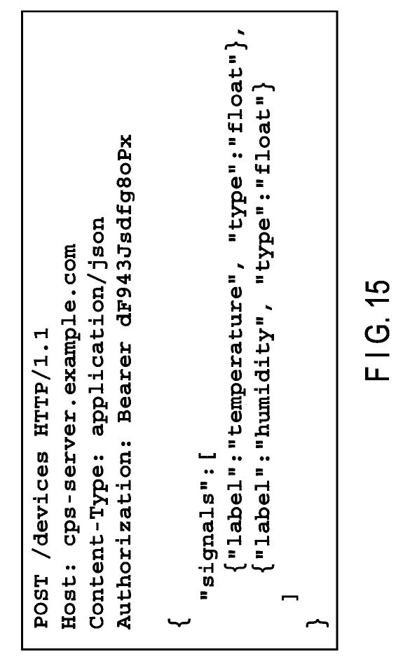

Now, the device registration process will be described. First, FIG. 15 shows an example of the device registration request described above. In the device registration request shown in FIG. 15, the access token is set in the Authorization HTTP header field. Note that the message body of the device registration request indicates that the CPS device 10 uploads sensor data called “temperature” and “humidity” to the CPS server 40.

When the device registration request is received by the first communication module 41 included in the CPS server 40, the second communication module 42 included in the CPS server 40 transmits the access token included in the device registration request to the authorization server 30.

The third communication module 39 included in the authorization server 30 receives an access token transmitted from the CPS server 40 (second communication module 42) and transmits (returns) the access token authorization user ID (the value in the “access token authorization user ID” column) contained in the session information including the access token, from among the multiple session information managed by the session management module 33, to the CPS server 40 as a response to the access token.

The second communication module 42 included in the CPS server 40 receives the access token authorized user ID transmitted from the authorization server 30 (third communication module 39). The registration processing module 43 included in the CPS server 40 registers (generates) information managed by the device management module 44 (hereinafter referred to as device information) based on the device registration request received by the first communication module 41 and the access token authorized user ID received by the second communication module 42.

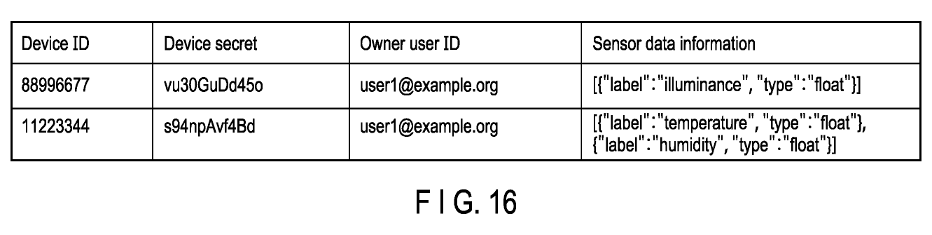

FIG. 16 shows an example of the device information. As shown in FIG. 16, the device information includes a device secret, owner user ID, and sensor data information, each associated with a device ID (device identification information).

The device ID is identification information for uniquely identifying a CPS device 10 registered with the CPS server 40. The device secret is a shared key for authenticating the CPS device 10 identified by the device ID. Note that the device ID and device secret are newly generated at the CPS server 40 (registration processing module 43) during registration of the device information.

The owner user ID is the user ID associated with the access token included in the device registration request (that is, the access token authorization user ID transmitted from the authorization server 30). Sensor data information corresponds to information (attribute information) such as sensors mounted on the CPS device 10 and data measured by the sensors, and is set based on data included in the device registration request (for example, “temperature” and “humidity” and the like).

Note that in the example shown in FIG. 16, device information containing device ID “88996677” and device information containing device ID ‘11223344’ are shown. Of these, the device information containing device ID “11223344” corresponds to the device information registered based on the device registration request shown in FIG. 15 described above.

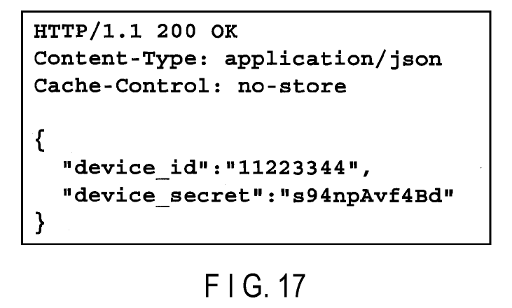

When the registration processing module 43 registers device information (entries) such as that shown in FIG. 16, the first communication module 41 transmits (returns) the device ID and device secret (value) contained in that device information to the CPS device 10 as a response to the device registration request (hereinafter referred to as the device registration response). Although detailed explanation is omitted, FIG. 17 shows an example of the device registration response.

By executing the device registration process (onboarding process) described above, the device ID and device secret (included in the device information) of the CPS device 10 registered with the CPS server 40 are registered in the CPS server 40 (device management module 44), and the device ID and device secret are shared with the CPS device 10.

With use of such a device ID and device secret, the CPS server 40 can authenticate the CPS device 10 that accessed the CPS server 40, and the CPS device 10 can upload sensor data (data measured by sensors mounted on the CPS device 10) to the CPS server 40. That is, the CPS server 40 can operate to receive sensor data only from CPS devices 10 authenticated using the device information (device ID and device secret) managed by the device management module 44 (that is, it permits access only from registered CPS devices 10).

Further, the device information managed by the device management module 44 includes an owner user ID for each CPS device 10 (that is, device ID). The sensor data management module 45 included in the CPS server 40 manages sensor data uploaded from registered CPS devices 10. The CPS server 40 can realize appropriate access control for this sensor data by utilizing the above-described owner user ID. Specifically, for example, the CPS server 40 can perform control such that sensor data uploaded from a specific CPS device 10 can be read only by the user who is the owner of that CPS device 10, thereby preventing situations where such sensor data leaks to third parties.

Further, in the device registration process described above, additional processing, such as setting the address of the CPS server 40 on the CPS device 10, may also be performed.

Incidentally, if the user does not permit (that is, rejects) the onboarding authorization request from the CPS device 10 on the authorization request app screen shown in FIG. 7, the user code and proximity attestation token are transmitted from the intermediary device 20 to the authorization server 30, as in the case where the onboarding authorization request is permitted, and for example, the first to seventh verification processes are executed. If verification succeeds in all of the first to seventh verification processes executed in this manner, the onboarding authorization request is rejected according to the user's instruction, and the target session information is deleted from the multiple session information managed by the authorization server 30 (session management module 33). On the other hand, if verification fails in at least one of the first to seventh verification processes, the target session information is not deleted but managed continuously.

As described above, the device registration system 1 according to this embodiment transmits an onboarding authorization request (an authorization request demanding authorization of a communication device) from the CPS device 10 to the authorization server 30 (first server device). In response to this onboarding authorization request, the device code, and the user code and proximity code generated by the authorization server 30 in response to the onboarding authorization request are transmitted from the authorization server 30 to the CPS device 10. Then, the hash value of the user code and the proximity code transmitted from the authorization server 30 are transmitted from the CPS device 10 to the intermediary device 20 (terminal device) located in the vicinity of the CPS device 10. Further, when an onboarding authorization request is permitted by a user using the intermediary device 20, the device registration system 1 according to this embodiment transmits a proximity attestation token created based on the hash value of the user code and the proximity code transmitted from the CPS device 10 from the intermediary device 20 to the authorization server 30. The authorization server 30 verifies the proximity attestation token transmitted from the intermediary device 20. If this verification succeeds, an access token to be managed in associated with the device code in the authorization server 30 is issued. Further, the device registration system 1 according to this embodiment transmits an access token request containing the device code from the CPS device 10 to the authorization server 30. Then, it transmits the access token managed in association with the device code included in the access token request transmitted from the CPS device 10 is transmitted to the CPS device 10 and transmits a device registration request containing the access token transmitted from the authorization server 30 from the CPS device 10 to the CPS server 40 (second server device).

In this embodiment, as described above, the CPS device 10 can be registered with the CPS server 40 in response to the device registration request transmitted from the CPS device 10 to the CPS server 40, and therefore it is possible to reduce security threats (risks) associated with performing onboarding.

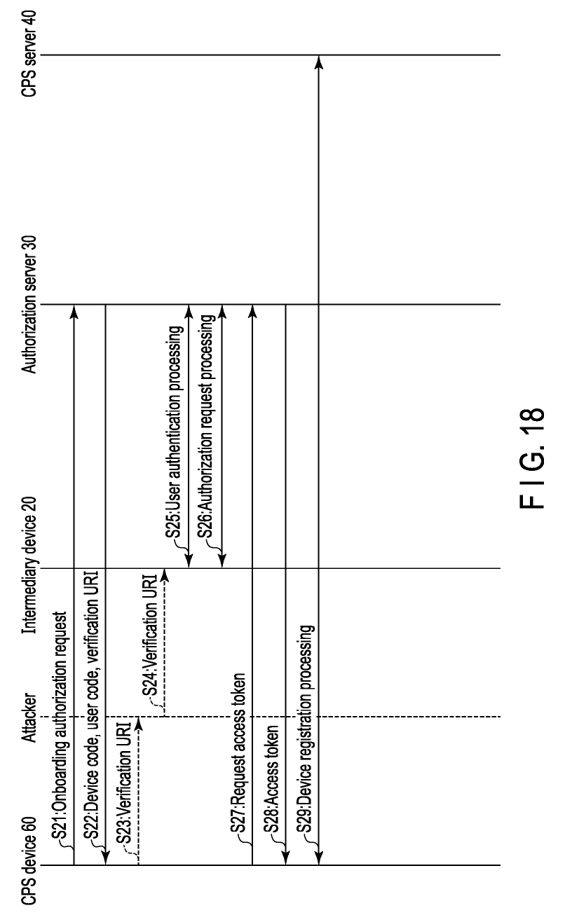

Now, with reference to FIG. 18, an example of a phishing attack that could be carried out during onboarding (onboarding using the method described in RFC 8628) corresponding to that of the comparative example of the present embodiment described above will be briefly explained. Here, such a case is assumed that a phishing attack is used to fraudulently register the CPS device 60 of an attacker with the CPS server 40.

First, the attacker boots the CPS device 60 and transmits an onboarding authorization request to the authorization server 30 (step S21). Note here that the processing in step S21 corresponds to the processing in step S1 shown in FIG. 7 described above.

Upon receiving the onboarding authorization request transmitted in step S21, the authorization server 30 transmits the device code, user code, and verification URI to the CPS device 60 based on RFC 8628 (step S22). Note that in step S22, unlike step S2 shown in FIG. 7 described above, the proximity code is not transmitted from the authorization server 30 to the CPS device 60.

Next, the attacker extracts the verification URI from the CPS device 60 (step S23). When it is assumed, for example, that the attacker has obtained the email address of the user (victim) using the intermediary device 20 through fraudulent means, the attacker can transmit the verification URI extracted in step S23 to the intermediary device 20 via email (step S24).

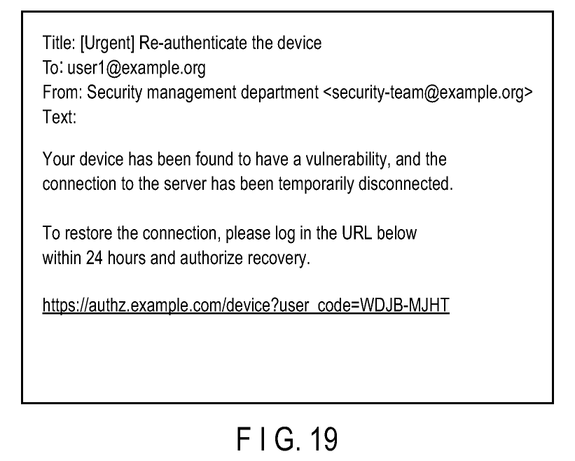

In this case, it is assumed that the attacker transmits an email with wording designed to trick the user into logging into the authorization server 30 and approving the onboarding authorization request from the CPS device 60, using methods such as impersonation and the like. FIG. 19 shows an example of the email (phishing email) transmitted in step S24. In the example shown in FIG. 19, the attacker impersonates the security management department of the user's organization and prompts the user to reconfirm the CPS device.

When a user who trusts the content of the email described above specifies the verification URI listed in the email, the intermediary device 20 accesses the authorization server 30, and the authorization server 30 executes the user authentication process for that user (step S25). The processing in step S25 corresponds to the processing in step S4 shown in FIG. 7 above. The authorization server 30 permits login by the user based on the user ID and password entered by the user and delivers the authorization request confirmation app to the intermediary device 20.

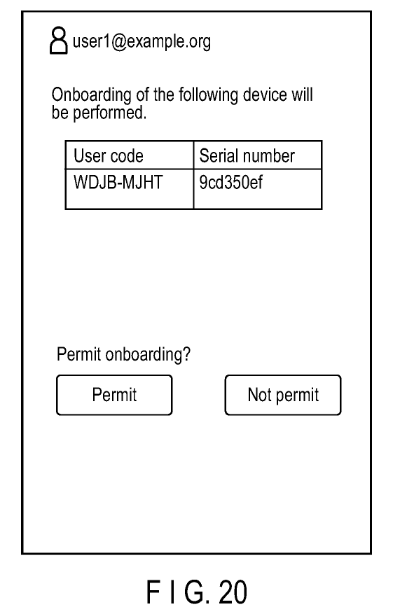

Here, since the comparison example of this embodiment does not use a proximity code, the authorization request confirmation app displays an authorization request confirmation app screen, as shown in FIG. 20, on the intermediary device 20.

Here, according to RFC 8628, the user should confirm that they have at hand a CPS device displaying the user code “WDJB-MJHT” shown on the authorization request confirmation app screen. That is, when the user can confirm that the CPS device 60 displaying the user code “WDJB-MJHT” is not at hand, the user can recognize that this user code “WDJB-MJHT” was not issued to the user’s own CPS device. Consequently, the user can avoid a phishing attack by not permitting the onboarding authorization request on the authorization request confirmation app screen.

However, if a user neglects the above-described verification process and accidentally permits the onboarding authorization request on the authorization request confirmation app screen, the authorization request processing is executed on the authorization server 30 (step S26).

If the onboarding authorization request is permitted in this authorization request processing, the authorization server 30 issues a new access token and registers the user ID of the user (user1@example.org) as the access token authorization user ID contained in the session information.

In this case, the CPS device 60 presents its device code to the authorization server 30 and requests an access token (step S27). In response, the authorization server 30 transmits the access token to the CPS device 60 (step S28). When the access token transmitted from the authorization server 30 is presented to the CPS server 40 and a request is made to register the CPS device 60 with the CPS server, the device registration process is executed (step S29). In this manner, the CPS device 60 is registered with the CPS server 40 as a CPS device owned by the user. Note that the processing in steps S27 to S29 corresponds to the processing in steps S9 to S11 shown in FIG. 7 described above.

As described above, if a CPS device 60 is registered with the CPS server 40 via a phishing attack, this CPS device 60 can upload sensor data to the account of the user (victim) managed by the CPS server 40. Accordingly, the attacker (CPS device 60) can disrupt the normal operation of the user's CPS by uploading false sensor data or large volumes of sensor data to the CPS server 40.

In the above-described step S24, the attacker could, for example, transmit a mass email (phishing email) to an unspecified number of people worldwide. For the attacker, the phishing attack can be considered successful if at least one recipient of the email trusts the content (text) of the email and permits the onboarding authorization request.

To permit the onboarding authorization request by the authorization server 30 in the device registration system 1 of this embodiment against such phishing attacks, the intermediary device 20 must transmit a proximity attestation token to the authorization server 30.

When the authorization request confirmation app is delivered from the authorization server 30 to the intermediary device 20 in this embodiment, the authorization request confirmation app screen shown in FIG. 12 described above is displayed, and the device enters a state of standing by for the proximity code.

As described above, to transmit the proximity attestation token to the authorization server 30 (that is, to generate the proximity attestation token), the intermediary device 20 must receive the proximity code from the CPS device 60 of the attacker. But, if the CPS device 60 is not located within a range capable of BLE communication with the intermediary device 20, the intermediary device 20 will not receive the proximity code from the CPS device 60.

That is, in this embodiment, even if the user permits the onboarding authorization request on the authorization request confirmation app screen, the onboarding authorization request will not be permitted at the authorization server 30 unless the CPS device 60 is located in the vicinity of the intermediary device 20.

With the above-described configuration, the users (victims targeted for attack) that an attacker can attack are significantly limited, making it highly likely that phishing attacks can be prevented before they occur.

Incidentally, as described above, even when the CPS device 60 of the attacker is not located in the vicinity of the intermediary device 20, it is conceivable that the attacker (CPS device 60) could transmit the proximity code obtained (received) from the authorization server 30 to the intermediary device 20. Specifically, for example, it is conceivable that the attacker could include the proximity code in the verification URI written in an email transmitted to the intermediary device 20 (by appending the proximity code as a query parameter to the verification URI).

However, the authorization request confirmation app in this embodiment is designed to transmit the proximity proof code obtained from the token creation module 25 to the authorization server 30. Therefore, even if a verification URI with an appended proximity code is transmitted, the authorization request confirmation app in this embodiment will not receive the proximity code and use it for creating a proximity attestation token.

On the other hand, if, for example, there is a cross-site scripting (XSS) vulnerability in the authorization server 30, an attacker could exploit this vulnerability to tamper with the authorization request confirmation app distributed by the authorization server 30. In such a case, there is a possibility that the operation of the authorization request confirmation app could potentially be altered to receive the proximity code appended to the verification URI described in the email, as described above.

However, in this embodiment, a proximity attestation token is required for the onboarding authorization request to be permitted at the authorization server 30, and this proximity attestation token is created using the private key managed by the token creation module 25. Here, even if the authorization request verification app is tampered with to receive a proximity code not received via BLE communication as described above, the authorization request verification app cannot directly access the private key managed by the token creation module 25. Therefore, it cannot create a proximity attestation token from that proximity code and cannot transmit the proximity attestation token from the intermediary device 20 to the authorization server 30 (meaning the onboarding authorization request is not permitted).

Therefore, in this embodiment, even if a proximity code is transmitted from the CPS device 60 to the intermediary device 20 by means other than BLE communication, it is still possible to avoid phishing attacks.

Further, in this embodiment, by verifying, for example, the digital signature included in the proximity attestation token (a digital signature created using a pre-prepared private key for the payload containing the hash value of the user code and proximity code) and the nonce generated at the authorization server 30, it is possible to prevent situations where an onboarding authorization request is improperly permitted.

Furthermore, in this embodiment, such a configuration is adopted that user authentication processing is performed between the intermediary device 20 and the authorization server 30. With this configuration, it is possible perform appropriate access control for sensor data uploaded from the CPS device 10 registered with the CPS server 40.

In this embodiment, the device registration system 1 can securely connect (register) the CPS device 10 to the CPS server 40 by executing the processing shown in FIG. 7. But, when it is possible to ensure that the CPS device 10 and the intermediary device 20 (user) are physically close to (in proximity with) each other to reduce security threats such as the above-described phishing attacks or the like, part of this processing may be omitted.

Specifically, in this embodiment, it is described that a proximity attestation token is created on the intermediary device 20 based on a proximity code received from the CPS device 10 via BLE communication, this proximity attestation token is transmitted from the intermediary device 20 to the authorization server 30, and verification of this proximity attestation token is performed on the authorization server 30. This embodiment may as well be configured such that the creation of the proximity attestation token is omitted. In place, the intermediary device 20 receives a proximity code from a nearby CPS device 10, transmits this proximity code from the intermediary device 20 to the authorization server 30, and the verification of this proximity code is performed at the authorization server 30.

Further, it is described in this embodiment that the authorization server 30 performs verification using the user code and proximity attestation token transmitted from the intermediary device 20, this embodiment need only perform verification of at least the proximity code. In other words, processing or the like related to verifying the user code, the nonce contained in the proximity attestation token, and the digital signature may be omitted.

Furthermore, it is described in this embodiment that a QR code is displayed on the CPS device 10 and read by the intermediary device 20 to transfer the verification URI from the CPS device 10 to the intermediary device 20, but this embodiment only requires that the intermediary device 20 be able to access the authorization server 30 based on the verification URI transmitted from the authorization server 30 to the CPS device 10 as the onboarding authorization response. Specifically, if, for example, the user manually enters the verification URI displayed on the CPS device 10 to the intermediary device 20, the processes described in this embodiment, such as displaying and reading the QR code, may be omitted.

Moreover, it is described in this embodiment that a user authentication process is executed. But if, for example, a user using the intermediary device 20 during the process shown in FIG. 7 does not need to log in to the authorization server 30, the user authentication process may be omitted.

Furthermore, it is described primarily in this embodiment that BLE communication occurring when a proximity code, etc., is transmitted from the CPS device 10 to the intermediary device 20. But this embodiment only requires assurance of that the CPS device 10 and the user are physically close to each other. In this case, communication between the CPS device 10 and the intermediary device 20 may be based on, for example, near field communication (NFC), or may utilize ultrasound, infrared, or visible light.

### Second Embodiment

Next, the second embodiment will be described. In the second embodiment, descriptions of parts identical to those in the first embodiment described above are omitted, and the description focuses primarily on parts differing from the first embodiment. Note that the system configuration of the device registration system, and the functional configurations of the CPS device, intermediary device, authorization server, and CPS server in this embodiment are similar to those in the first embodiment described above. Therefore, they are described as appropriate using FIGS. 1 - 5.

In the first embodiment described above, the intermediary device 20 receives the hash value of the user code and the proximity code (BLE message) transmitted from the CPS device 10 via BLE communication, and the onboarding for the CPS device 10 is performed when the user permits the onboarding authorization request from the CPS device 10 on the authorization request confirmation app screen. But, when onboarding a great number of CPS devices 10, the operation of permitting onboarding authorization requests individually from each CPS device 10 is time-consuming, labor-intensive, and cumbersome for the user.

Under these circumstances, this embodiment is different from the above-described first embodiment in that it allows the user to be able to permit onboarding authorization requests from multiple CPS devices 10 in a single batch. Note that as described above, the configuration of the device registration system 1 (CPS device 10, intermediary device 20, authorization server 30, and CPS server 40) is generally similar to that of the first embodiment described earlier. But, in this embodiment, the behavior of the authorization request confirmation app primarily differs from that of the first embodiment.

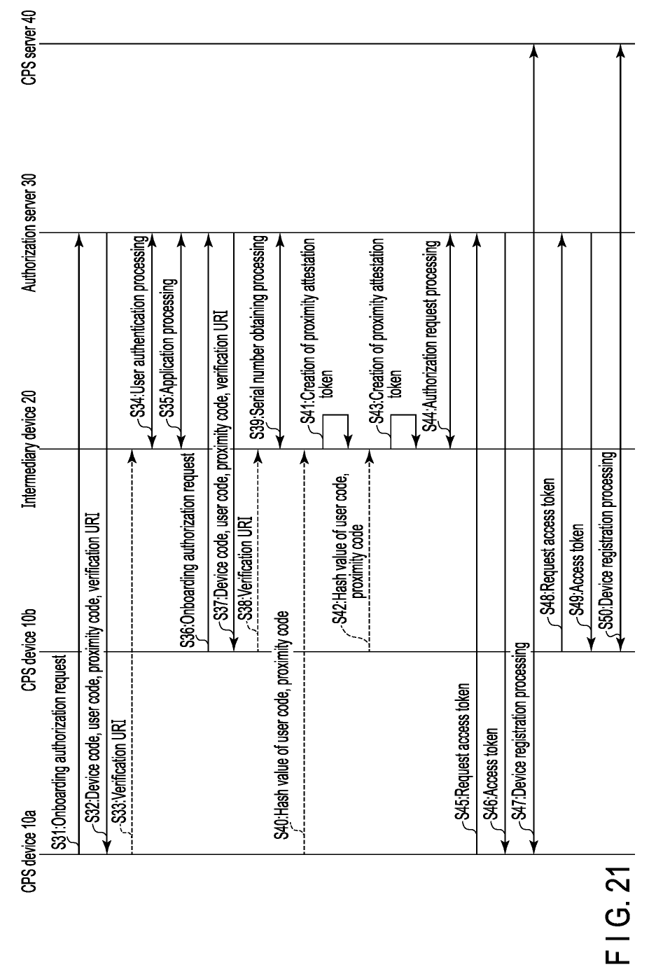

Now, with reference to the sequence chart in FIG. 21, an example of the processing procedure (operation sequence) of the device registration system 1 according to this embodiment will be described. In the example shown in FIG. 21, CPS devices 10a and 10b are shown as multiple CPS devices 10 (CPS devices 10 in a pre-onboarding state).

First, the processing of steps S31 to S35 is executed, which correspond to the processing of steps S1 to S5 shown in FIG. 7 described above in the case where the CPS device 10 in FIG. 7 is designated as a CPS device 10a (the first CPS device).

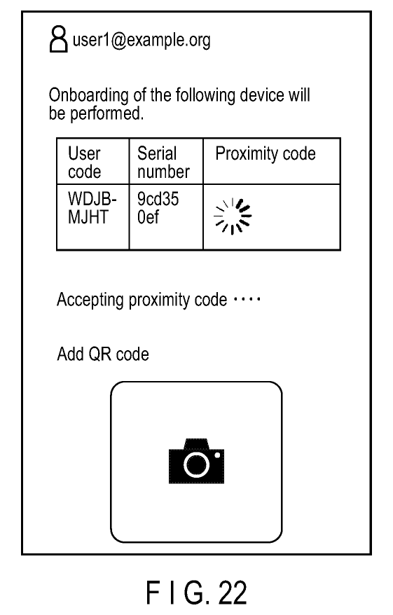

Here, FIG. 22 shows an example of the authorization request confirmation app screen in this embodiment. The authorization request confirmation app screen shown in FIG. 22 displays a user code and a serial number similar to those of FIG. 12 previously described. It also indicates that the authorization request confirmation app is in a state where it is accepting the proximity code from the CPS device 10a.

Further, the authorization request confirmation app screen in this embodiment is designed to enable the intermediary device 20 to additionally read a QR code.

In this case, processing of steps S36 to S38 is executed, which correspond to the processing of steps S1 to S3 shown in FIG. 7 described above when the CPS device 10 is replaced with the CPS device 10b (the second CPS device).

As described earlier, since the device code, user code, and proximity code are random strings, the device code, user code, and proximity code transmitted from the authorization server 30 to the CPS device 10b as the onboarding authorization response in step S37 are different respectively from the device code, user code, and proximity code transmitted from the authorization server 30 to the CPS device 10a as the onboarding authorization response in the above-described step S32.

When the QR code displayed on the CPS device 10b in step S38 is read by the intermediary device 20, the intermediary device 20 (authorization request confirmation app) obtains a new verification URI by decoding that QR code.

The authorization request confirmation app parses the verification URI thus obtained and obtains the user code contained in that verification URI.

In this case, the authorization request confirmation app executes processing to obtain the serial number of the CPS device 10b using the user code thus obtained (step S39). Specifically, the authorization request app (intermediary device 20) transmits the user code to the authorization server 30 to inquire about the serial number corresponding to that user code. At the authorization server 30, processing is executed to search for session information containing the user code transmitted from the intermediary device 20 and to transmit (reply) the serial number contained in the searched session information to the intermediary device 20 as a response to the inquiry.

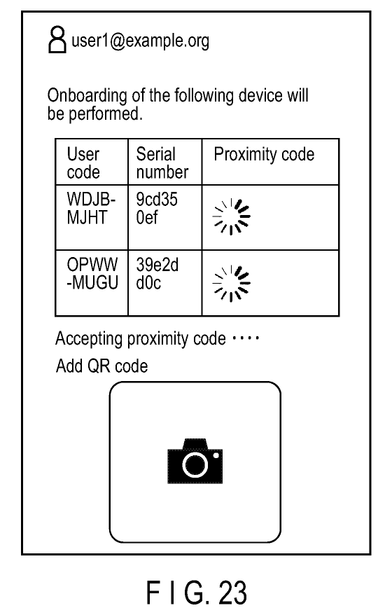

Upon obtaining (receiving) the serial number transmitted from the authorization server 30 as described above, the authorization request confirmation app updates the authorization request confirmation app screen shown in FIG. 22 to the authorization request confirmation app screen shown in FIG. 23.

In the authorization request confirmation app screen shown in FIG. 23, the user codes and serial numbers for each of the CPS device 10a and CPS device 10b (that is, the two CPS devices) are displayed. It also indicates that the system is in a state of accepting proximity codes from these CPS devices 10a and 10b.

In this case, the processing of steps S40 and S41 is executed, which corresponds to the processing of steps S6 and S7 shown in FIG. 7 described above when the CPS device 10 is designated as the CPS device 10a.

Similarly, the processing of steps S42 and S43 is executed, which corresponds to the processing of steps S6 and S7 shown in FIG. 7 described above when the CPS device 10 is designated as the CPS device 10b.

Note that the example shown in FIG. 21 is on the assumption that the same nonce is used to create the proximity attestation token in steps S41 and S43. But, different nonces may be generated (issued) for the CPS devices 10a and 10b, respectively, and these different nonces may be used to create the proximity attestation token in steps S41 and S43.

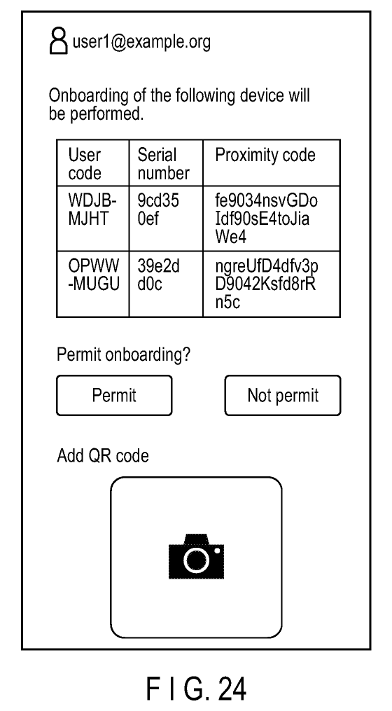

When proximity attestation tokens are thus created for the CPS devices 10a and 10b, respectively, the thus created proximity attestation tokens are provided to the authorization request confirmation app. The authorization request confirmation app then updates the authorization request confirmation app screen shown in FIG. 23 to the authorization request confirmation app screen shown in FIG. 24 based on the provided proximity attestation tokens.

Here, in this embodiment, the user can collectively permit the onboarding authorization requests from the CPS devices 10a and 10b by performing the operation of pressing down the button labeled “Permit” placed on the authorization request confirmation app screen shown in FIG. 24. When the onboarding authorization requests from the CPS devices 10a and 10b are thus permitted in a batch, the intermediary device 20 transmits the respective user codes and proximity attestation tokens of the CPS devices 10a and 10b to the authorization server 30.

Note that after the respective user codes and proximity attestation tokens for the CPS devices 10a and 10b are transmitted from the intermediary device 20 to the authorization server 30, processing similar to that of the first embodiment described before is executed for each of the CPS devices 10a and 10b. Specifically, the processing of steps S44 to S47 is executed, which corresponds to the processing of steps S8 to S11 shown in FIG. 7 described above when the CPS device 10 shown in that figure is designated as the CPS device 10a. Further, the processing of steps S44 and S48 to S50 is executed, which corresponds to the processing of steps S8 to S11 shown in FIG. 7 described above when the CPS device 10 is designated as the CPS device 10b.

As described above, in this embodiment, for example, when onboarding authorization requests (a first authorization request requesting authorization for the first communication device and a second authorization request requesting authorization for the second communication device) are transmitted from the CPS devices 10a and 10b to the authorization server 30, proximity codes (first and second proximity codes) are generated for the respective CPS device 10a and 10b. Further, in this embodiment, when the QR codes displayed on the respective CPS devices 10a and 10b are read by the intermediary device 20 and the proximity codes are received from the respective CPS devices 10a and 10b, the user can collectively permit the onboarding authorization requests for the respective CPS devices 10a and 10b in a batch.

Note that this embodiment is described in connection with the case where there are two CPS devices 10 (CPS devices 10a and 10b). But, even if there are three or more CPS devices 10, the user can still permit onboarding authorization requests from all CPS devices 10 in a batch simply by reading the QR codes displayed on the respective CPS devices 10.

In this embodiment, with the above-described configuration, it is possible to reduce user effort even when onboarding must be performed for a large number of CPS devices 10.

### Third Embodiment

Next, the third embodiment will be described. In the third embodiment, descriptions of parts identical to the above-described first embodiment are omitted, and the focus is primarily on parts differing from that first embodiment. Note that the system configuration of the device registration system pertaining to this embodiment is similar to that of the above-described first embodiment; therefore, the explanation will be made with reference to FIG. 1 as appropriate.

In the first embodiment described above, the explanation is made on the assumption that the CPS device 10 is pre-connected to the network 50 (meaning the CPS device 10 is already in a state capable of communicating with the authorization server 30 and the CPS server 40). However, when actually performing onboarding for the CPS device 10, the operation of connecting that CPS device 10 to the network 50 is necessary, and performing such an operation manually is cumbersome. Under these circumstances, this embodiment is different from the first embodiment described above in that the operation of connecting the CPS device 10 to the network 50 when performing onboarding is automatically performed.

In this embodiment, the Device Provisioning Protocol (DPP) is used as the protocol for connecting the device to the network. The DPP is also known as Wi-Fi Easy Connect, and is a protocol for operating the automatic configuration of the connection to wireless LAN. In the DPP, a dedicated QR code held by the device connecting to the wireless LAN (client device) is read (scanned) using a smartphone or similar device (configuration device), the configuration device can transmit wireless LAN connection settings (such as SSID and password) to the client device. Note here that the client device is referred to as the Enrollee, and the configuration device is referred to as the Configurator. In this embodiment, the CPS device 10 operates as the Enrollee, and the intermediary device 20 operates as the Configurator.

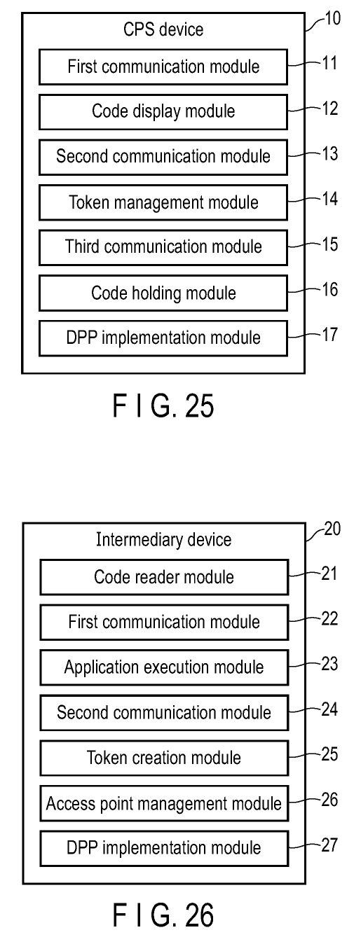

FIG. 25 shows an example of the functional configuration of the CPS device 10 in this embodiment. In FIG. 25, identical reference numerals are used for parts identical to those in the FIG. 2 described above, and their detailed descriptions are omitted. Here, the parts differing from those of FIG. 2 are primarily described. As shown in FIG. 25, the CPS device 10 includes a code holding module 16 and a DPP implementation module 17.

The code holding module 16 holds a QR code (DPP QR code) used to set wireless LAN connections via DPP. The DPP QR code held in the code holding module 16 is displayed by the code display module 12. In this embodiment, it is assumed that the DPA QR code is displayed by the code display module 12, for example, on a display. But, this DPA QR code may as well be affixed to the surface of the housing of the CPS device 10, or printed on the packaging containing the CPS device 10, or printed in the instruction manual of the CPS device 10, for example. In other words, it suffices if the DPA QR code in this embodiment is provided in a manner readable by the intermediary device 20 (Configurator).

The DPP implementation module 17 performs communication according to the DPP as the Enrollee described above, receives connection setting information for the wireless LAN from the intermediary device 20, and executes processing (hereinafter referred to as connection setting processing) to connect the CPS device 10 to the wireless LAN based on the connection setting information.

Here, the first embodiment provided above is described on the assumption that the second communication module 13 performs BLE communication with the intermediary device 20, whereas in this embodiment, the second communication module 13 performs communication based on the wireless LAN with the intermediary device 20, as described above, by the DPP implementation module 17 performing the connection setting processing.

Further, the above-provide first embodiment is described on the assumption that the verification URI is transferred from the CPS device 10 to the intermediary device 20 by the code display module 12 displaying a QR code converted from the verification URI (hereinafter referred to as the verification URI QR code). On the other hand, in this embodiment, the verification URI is transmitted to the intermediary device 20 via wireless LAN communication performed by the second communication module 13 (that is, via the wireless LAN).

Furthermore, in the first embodiment described above, it is assumed that the hash value of the user code and the proximity code are transmitted to the intermediary device 20 via BLE communication. On the other hand, in this embodiment, the hash value of the user code and the proximity code are transmitted to the intermediary device 20 via wireless LAN communication performed by the second communication module 13 (that is, via the wireless LAN).

That is, the first embodiment provided above is described on the assumption that the BLE communication is performed between the CPS device 10 and the intermediary device 20. On the other hand, in this embodiment, communication based on wireless LAN occurs between the CPS device 10 and the intermediary device 20, which is achieved by performing the connection setting for the CPS device 10 to the wireless LAN before onboarding is performed.

FIG. 26 shows an example of the functional configuration of the intermediary device 20 according to this embodiment. In FIG. 26, identical reference numerals are used for parts identical to those in FIG. 3 described above, and their detailed descriptions are omitted. Here, the parts differing from those of FIG. 3 are primarily described. As shown in FIG. 26, the intermediary device 20 includes an access point management module 26 and a DPP implementation module 27.

The access point management module 26 launches an access point for connecting the CPS device 10 to a wireless LAN. Note that the access point launched by the access point management module 26 corresponds to the wireless LAN access point for onboarding the CPS device 10.

The DPP implementation module 27 performs communication according to the DPP as the above-described Configurator and provides connection setting information to the CPS device 10.

In the first embodiment described above, it is assumed that the code reader module 21 reads a verification URI QR code displayed on the CPS device 10. But, in this embodiment, a verification URI QR code is not displayed on the CPS device 10. With this configuration, the code reader module 21 in this embodiment does not need to read such a verification URI QR code. In place, the code reader module 21 reads the DPP QR code when such a DPP QR code is displayed on the CPS device 10.

Further, the first embodiment provided above is described on the assumption that the second communication module 24 performs the BLE communication with the CPS device 10. But, in this embodiment, it is assumed that the second communication module 24 performs communication with the CPS device 10 based on wireless LAN.

With this configuration of the embodiment, the second communication module 24 receives a verification URI transmitted via wireless LAN from the CPS device 10 (second communication module 13). Similarly, the second communication module 24 receives the hash value of the user code and the proximity code transmitted via wireless LAN from the CPS device 10 (second communication module 13).

Note that in the first embodiment described above, it is assumed that the proximity attestation token is created based on the proximity code transmitted from the CPS device 10 via BLE communication. But, in this embodiment, the token creation module 25 creates the proximity attestation token based on the proximity code transmitted from the CPS device 10 via communication based on wireless LAN. Therefore, the token creation module 25 in this embodiment may be implemented within the hardware for wireless LAN-based communication (the wireless chip performing wireless LAN communication).

Here, the functional configurations of the CPS device 10 and the intermediary device 20 in this embodiment are described. Note that the functional configurations of the authorization server 30 and the CPS server 40 in this embodiment are similar to those described in the first embodiment, and therefore the detailed descriptions thereof will be omitted here.

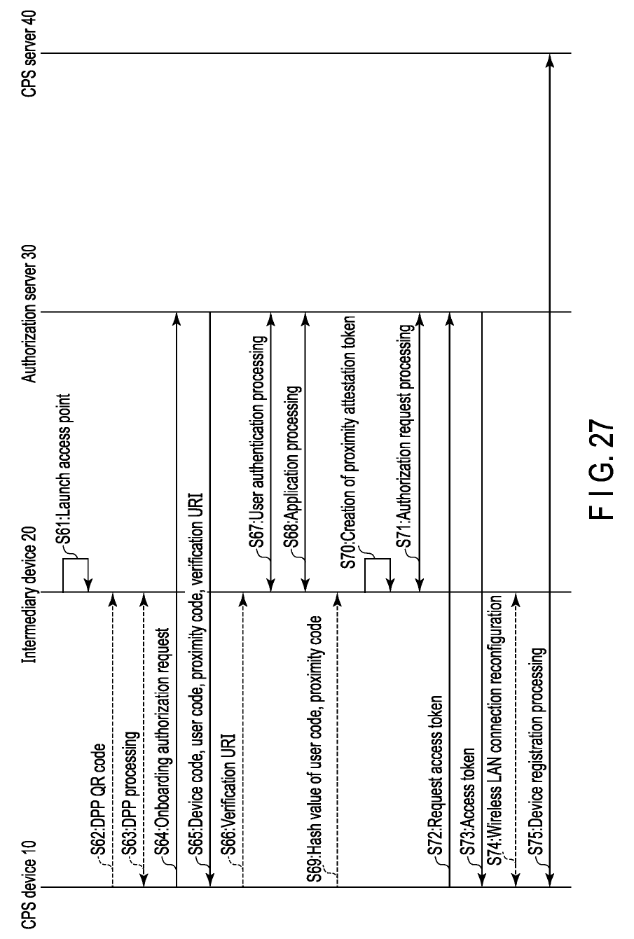

Now, with reference to the sequence chart in FIG. 27, an example of the processing procedure (operation sequence) of the device registration system 1 according to this embodiment will be described.

Note that, unlike the first embodiment described above, it is assumed here that, at the start of the processing shown in FIG. 27, the CPS device 10 is not yet in a state where it is communicatively connected to the authorization server 30 and the CPS server 40 (that is, it is not connected to the network 50).

First, the access point management module 26 included in the intermediary device 20, for example, in response to the user’s operation, launches a wireless LAN access point on the intermediary device 20 for onboarding the CPS device 10 (step S61). It is assumed here that the intermediary device 20 has a network interface (for example, a mobile phone communication line and the like) separate from the wireless LAN access point and is capable of communicating with the authorization server 30 via this network interface.

Next, for example, the code display module 12 included in the CPS device 10 displays the DPA QR code held in the code holding module 16, and the code reader module 21 included in the intermediary device 20 reads this DPA QR code (step S62).

When the processing of step S62 is executed, the DPP implementation module 27 (Configurator) included in the intermediary device 20 performs communication with the DPP implementation module 17 (Enrollee) included in the CPS device 10 according to the DPP and executes the DPP processing (step S63). In step S63, connection setting information for the onboarding wireless LAN access point is transmitted from the intermediary device 20 (DPP implementation module 27) to the CPS device 10 (DPP implementation module 17). Then, the CPS device 10 executes the processing to connect to the access point using this connection setting information (that is, the wireless LAN connection setting for the CPS device 10).

By executing the above-described DPP processing, the CPS device 10 is connected to the wireless LAN and becomes able to communicate with the intermediary device 20 based on that wireless LAN. Note that the wireless LAN to which the CPS device 10 connects in this manner is a network temporarily constructed and deployed for onboarding purposes, and it is referred to below as the onboarding wireless LAN.

The CPS device 10 is connected to the intermediary device 20 via the onboarding wireless LAN and further connected to the network 50 via the network interface (for example, mobile phone communication line) possessed by the intermediary device 20. With this configuration, the CPS device 10 becomes able to communicate with the authorization server 30. This connection configuration is referred to as tethering.

Now, the processing of steps S64 to S73 is executed, which corresponds to the processing of steps S1 to S10 shown in FIG. 7 described above. Note here that, as described above, communication between the CPS device 10, the intermediary device 20, and the authorization server 30 is performed via the onboarding wireless LAN.

Specifically, in step S64, an onboarding authorization request is transmitted from the CPS device 10 to the authorization server 30 via the onboarding wireless LAN. Further, in step S65, an onboarding authorization response (containing the device code, user code, proximity code, and verification URI) is transmitted from the authorization server 30 to the CPS device 10 via the onboarding wireless LAN.

Furthermore, in step S66, the CPS device 10 transmits the verification URI to the intermediary device 20 via the onboarding wireless LAN. Also, in step S69, the CPS device 10 transmits the hash value of the user code and the proximity code to the intermediary device 20 via the onboarding wireless LAN.

Similarly, in step S72, an access token is requested from the authorization server 30 via the onboarding wireless LAN from the CPS device 10. In step S73, the access token is transmitted from the authorization server 30 to the CPS device 10 via this onboarding wireless LAN.

Note that according to the connection configuration referred to as the tethering described above, the CPS device 10 can perform communication based on the onboarding wireless LAN when it is within a range of, for example, approximately 10m to 15m from the intermediary device 20. In the first embodiment described above, when the proximity code from the CPS device 10 is received by the intermediary device 20 via BLE communication, it is ensured that the CPS device 10 and the user (intermediary device 20) are physically close to each other. On the other hand, in this embodiment, the CPS device 10 and the intermediary device 20 are configured to communicate based on the above-described onboarding wireless LAN, thereby ensuring that the CPS device 10 and the user are physically close. Note that the communication range for the onboarding wireless LAN-based communication may be adjusted based on the signal intensity or the like in the communication.

It should be noted here that, as described above, the CPS device 10 can communicate based on the onboarding wireless LAN, but this onboarding wireless LAN is a temporary network prepared for onboarding, and it is not appropriate to continue using this onboarding wireless LAN when actually operating the CPS.

Under such circumstances, when the access token transmitted from the authorization server 30 is received by the CPS device (first communication module 11) in step S73, the processing to reconfigure the wireless LAN connection between the CPS device 10 and the intermediary device 20 is executed (step S74). Note that reconfiguration of the wireless LAN connection is included in the DPP specification and is known as DPP Reconfiguration.

In step S74, the CPS device 10 requests reconfiguration of the wireless LAN connection from the intermediary device 20. Such processing is then executed, that the intermediary device 20 returns, to the CPS device 10, the connection setting (configuration) information for the wireless LAN (access point) to which the CPS device 10 should ultimately connect. It is assumed that the wireless LAN to which the CPS device 10 should ultimately connect is the wireless LAN deployed in the building or facility where the CPS device 10 is installed, and the connection setting (configuration) information for this wireless LAN is pre-stored by the intermediary device 20.

When the process of step S74 is executed to complete the reconfiguration of the wireless LAN connection (that is, connecting to the wireless LAN), communication based on that wireless LAN occurs between the CPS device 10 and the CPS server 40. In this manner, the processing of step S75 is executed, which corresponds to the processing of step S11 shown in FIG. 7 described above.

As described above, in this embodiment, when onboarding is performed for the CPS device 10, the CPS device 10 is connected to the network 50 capable of communicating with the authorization server 30 via the intermediary device 20.

In this embodiment having such a configuration as described above, network connection settings can be automatically implemented in addition to onboarding for the CPS device 10 simply by reading the DPP QR code held by the CPS device 10, for example, on the intermediary device 20. Therefore, the user's effort can be reduced.

Furthermore, in this embodiment, the proximity code is transmitted from the CPS device 10 to the intermediary device 20 via the onboarding wireless LAN, and therefore it can be assured that the CPS device 10 and the user (intermediary device 20) are in close proximity. Accordingly, as in the case of the first embodiment described above, this embodiment can also avoid phishing attacks and reduce security threats.

Note that this embodiment is described on the assumption that the connection settings for the onboarding wireless LAN to the CPS device 10 is performed by communication between the CPS device 10 (DPP implementation module 17) and the intermediary device 20 (DPP implementation module 27) according to the DPP. But, this embodiment may as well be configured such that connection settings according to protocols other than the DPP are performed, provided that the CPS device 10 can be automatically connected to the network 50 (that is, placing the CPS device 10 in a state capable of communicating with the authorization server 30).

According to at least one of the embodiments described above, it is possible to provide a device registration system, terminal device, and method which can reduce security threats.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device registration system comprising a communication device, a terminal device, and a first server device, wherein
the communication device is configured to transmit an authorization request which requests authorization of the communication device, to the first server device;
the first server device is configured to transmit a device code and a proximity code generated at the first server device in response to the authorization request, to the communication device;
the communication device is in vicinity of the terminal device and is configured to transmit the proximity code transmitted from the first server device, to the terminal device;
the terminal device is configured to transmit, when the authorization request is permitted by a user using the terminal device, the proximity code transmitted from the communication device, to the first server device;
the first server device is configured to verify the proximity code transmitted from the terminal device;
the first server device is configured to issue an access token managed to be associated with the device code when the verification is successful;
the communication device is configured to transmit an access token request including the device code transmitted from the first server device, to the first server device;
the first server device is configured to transmit an access token managed to be associated with the device code included in the access token request transmitted from the communication device, to the communication device; and
the communication device is configured to transmit a device registration request including the access token transmitted from the first server device, to a second server device.

2. The device registration system of claim 2 wherein
the proximity code is transmitted from the communication device to the terminal device by performing communication based on Bluetooth Low Energy (BLE).

3. The device registration system of claim 1,
wherein
the first server device is configured to transmit a user code generated at the first server device in response to the authorization request, to the communication device,
the communication device is configured to transmit a hash value of the user code transmitted from the first server device, to the terminal device,
the terminal device is configured to create a proximity attestation token based on the proximity code and the hash value of the user code transmitted from the communication device,
the terminal device is configured to transmit the proximity attestation token, to the first server device, and
the first server device is configured to verify the proximity attestation token transmitted from the terminal device.

4. The device registration system of claim 3, wherein
the proximity attestation token includes a payload including the proximity code and the hash value of the user code, and an electronic signature created using a private key prepared in advance for the payload, which is verified using the public key that is in a pair of the private key.

5. The device registration system of claim 3, wherein
the first server device is configured to transmit a nonce generated at the first server device, to the terminal device,
the terminal device is configured to create the proximity attestation token based on the nonce transmitted from the first server device,
the first server device is configured to verify the proximity attestation token based on a validity period set for the nonce.

6. The device registration system of claim 1, wherein
the first server device is configured to transmit access information for accessing the first server device generated in response to the authorization request, to the communication device,
the communication device is configured to display a two-dimensional code representing the access information transmitted from the first server device,
the terminal device is configured to read the displayed two-dimensional code, and
the terminal device is configured to access the first server device by reading the two-dimensional code.

7. The device registration system of claim 1, wherein
an authentication process for the user is executed between the terminal device and the first server device,
the first server device is configured to manage user identification information for identifying the user for whom the authentication process is executed, so as to be associated with the access token, when an access token is issued, and
the user identification information is transmitted from the first server device to the second server device when the access token included in the device registration request is transmitted from the second server device to the first server device, and is managed at the second server device to be associated with device identification information for identifying the communication device.

8. The device registration system of claim 1, wherein
the communication device includes first and second communication devices,
when a first authorization request requesting authorization of the first communication device is transmitted from the first communication device to the first server device, a first device code and a first proximity code are generated in response to the first authorization request,
when a second authorization request requesting authorization of the second communication device is transmitted from the second communication device to the first server device, a second device code and a second proximity code are generated in response to the second authorization request, and
when the first proximity code is transmitted from the first communication device to the terminal device, and the second proximity code is transmitted from the second communication device to the terminal device, the first and second authorization requests are collectively permitted by the user operating the terminal device.

9. The device registration system of claim 1, wherein
the communication device is connected to a network which can communicate with the first server device, via the terminal device.

10. The device registration system of claim 9, wherein
connection configuration for the communication device to the wireless LAN is performed by communicating between the communication device and the terminal device according to Device Provisioning Protocol (DPP), and
the proximity code is transmitted from the communication device to the terminal device by communicating based on the wireless LAN.

11. A terminal device communicatively connected to a communication device and a first server device, the terminal device comprising:
a processor configured to:
receive a proximity code generated at the first server device in response to an authorization request requesting authorization of the communication device, from the communication device located in vicinity of the terminal device; and
transmit the received proximity code to the first server device when the authorization request is permitted by a user using the terminal device, wherein
the first server device is configured to issue an access token managed to be associated with the device code generated at the first server device in response to the authorization request when verification of the proximity code is successful, and
the communication device is configured to transmit an access token request including the device code to the first server device, thereby receiving the access token managed at the first server device to be associated with the device code, and transmit a device registration request including the received access token to a second server device.

12. A method executed by a device registration system comprising a communication device, a terminal device, and a first server device, the method comprising:
transmitting an authorization request which requests authorization of the communication device, from the communication device to the first server device;
transmitting a device code and a proximity code generated at the first server device in response to the authorization request, from the first server device to the communication device;
transmitting the proximity code transmitted from the first server device, from the communication device located in vicinity of the terminal device, to the terminal device;
transmitting, when the authorization request is permitted by a user using the terminal device, the proximity code transmitted from the communication device, from the terminal device to the first server device;
verifying the proximity code transmitted from the terminal device at the first server device;
issuing an access token managed at the first server device to be associated with the device code when the verification is successful;
transmitting an access token request including the device code transmitted from the first server device, from the communication device to the first server device;
transmitting an access token managed to be associated with the device code included in the access token request transmitted from the communication device, from the first server device to the communication device; and
transmitting a device registration request including the access token transmitted from the first server device, from the communication device to a second server device.
